(19) United States
(12) Patent Application Publication
(10) Pub. No.: US 2024/0247739 A1
(43) Pub. Date: Jul. 25, 2024

(54) LOCKING MECHANISMS FOR CONDUIT FASTENER ASSEMBLIES

(71) Applicant: Enduralock, LLC, Lenexa, KS (US)

(72) Inventors: Harold Hess, Leawood, KS (US); Deeptesh Selvaraj, Pitt Meadows (CA); Caleb Grabill, Leavenworth, KS (US)

(21) Appl. No.: 18/417,151

(22) Filed: Jan. 19, 2024

Related U.S. Application Data
(60) Provisional application No. 63/440,298, filed on Jan. 20, 2023.

(51) Int. Cl. F16L 19/00; F16L 19/025

(52) U.S. Cl. CPC F16L 19/005; F16L 19/025

(57) ABSTRACT

A fastener assembly includes a tube fitting defining a longitudinal axis, a lock assembly releasably coupled to the tube fitting and including teeth, and a conduit nut. The conduit nut defines an inner cavity sized and shaped to receive a portion of the tube fitting. The conduit nut includes a circumferential wall extending about a periphery of the conduit nut, and notches. The lock assembly is positionable between a locked position in which the teeth are engaged with the notches and an unlocked position in which the teeth are spaced from the notches. The tube fitting is fixed against rotation within the inner cavity when the lock assembly is in the locked position. The tube fitting is rotatable within the inner cavity when the lock assembly is in the unlocked position.

### CROSS-REFERENCE TO RELATED APPLICATION

This application claims priority to U.S. Provisional Application Ser. No. 63/440,298, filed on Jan. 20, 2023, the content of which is hereby incorporated by reference in its entirety.

### BACKGROUND

The field of the disclosure relates generally to fasteners, and more specifically to locking mechanisms for threaded fasteners.

Fasteners commonly include mechanisms for ensuring that fastener elements do not loosen over time, potentially allowing joined elements to loosen or separate. Examples of mechanisms include thread bore inserts, and screw thread profiles that deform when tightened. Fasteners accessories like lock washers, cotter pins, and lock wires are also commonly used with fasteners to prevent fastener elements from loosening. Adhesive materials, like epoxy, can be applied to fastener threads to stake fastener elements to prevent fastener elements from loosening. Such conventional mechanisms, accessories, and adhesive materials have generally been considered satisfactory for their intended purpose. However, such conventional fastener mechanisms, accessories, and adhesive materials may not be suitable for some applications, such as high pressure fluid connectors, high temperature environments, and/or with structures subject to vibration.

### BRIEF DESCRIPTION

In an aspect, a fastener assembly generally comprises a tube fitting defining a longitudinal axis, a lock assembly releasably coupled to the tube fitting and including teeth, and a conduit nut. The conduit nut defines an inner cavity sized and shaped to receive a portion of the tube fitting. The conduit nut includes a circumferential wall and notches. The lock assembly is positionable between a locked position in which the teeth are engaged with the notches and an unlocked position in which the teeth are spaced from the notches. The tube fitting is fixed against rotation within the inner cavity when the lock assembly is in the locked position. The tube fitting is rotatable within the inner cavity when the lock assembly is in the unlocked position.

In another aspect, a lock assembly for a tube fitting defining a longitudinal axis generally comprises a lock member, a sleeve, and a conduit nut. At least one of the lock member or the sleeve includes teeth. The conduit nut defines an inner cavity sized and shaped to receive a portion of the tube fitting therein. The conduit nut including notches. The lock assembly is positionable between a locked position in which the teeth are engaged with the notches and an unlocked position in which the teeth are spaced from the notches. The tube fitting is fixed against rotation within the inner cavity when the lock assembly is in the locked position, and the tube fitting is rotatable within the inner cavity when the lock assembly is in the unlocked position.

In yet another aspect, a conduit fastener assembly includes a tube fitting defining a longitudinal axis. The tube fitting includes a fitting body having a first portion and a second portion. The conduit fastener assembly includes a first conduit nut defining a first inner cavity sized and shaped to receive the first portion of the tube fitting therein, and a second conduit nut defining a second inner cavity sized and shaped to receive the second portion of the tube fitting therein. The first conduit nut includes a first wall extending about a periphery of the first conduit nut. The first wall includes first notches. The second conduit nut includes a second wall extending about a periphery of the second conduit nut. The second wall includes second notches. The conduit fastener assembly includes a lock assembly releasably coupled to the tube fitting and including teeth. The lock assembly is positionable between a locked position in which the teeth are engaged with the first and second notches and an unlocked position in which the teeth are spaced from the first and second notches. The tube fitting is fixed against rotation within the first inner cavity and the second inner cavity when the lock assembly is in the locked position. The tube fitting is rotatable within the first inner cavity and the second inner cavity when the lock assembly is in the unlocked position.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an example of a conduit fastener assembly including a lock assembly in a locked position;

FIG. 2 is a perspective view of the conduit fastener assembly of FIG. 1, the lock assembly in an unlocked position;

FIG. 3 is an enlarged perspective view of the conduit fastener assembly of FIG. 1, the lock assembly in the locked position;

FIG. 4 is a cross-section view of the conduit fastener assembly of FIG. 1, the lock assembly in the locked position;

FIG. 5 is an enlarged perspective view of the conduit fastener assembly of FIG. 1, the lock assembly in the unlocked position;

FIG. 6 is a cross-section view of the conduit fastener assembly of FIG. 1, the lock assembly in the unlocked position;

FIG. 7 is a perspective view of a portion of the conduit fastener assembly of FIG. 1, the conduit fastener assembly including a tube fitting and the lock assembly;

FIG. 8 is an exploded perspective view of the tube fitting and the lock assembly of FIG. 7;

FIG. 9 is a perspective view of a lock member coupled to the tube fitting of FIG. 8;

FIG. 10 is a perspective view of a conduit nut of the conduit fastener assembly of FIG. 1;

FIG. 11 is a top view of the conduit nut of FIG. 10;

FIG. 12 is a perspective view of the conduit fastener assembly of FIG. 1 and a tool for tightening or loosening the conduit fastener assembly if the lock assembly is in the unlocked position;

FIG. 13 is an enlarged perspective view a portion of the conduit fastener assembly and the tool of FIG. 12, with a portion of the tool illustrated as transparent to show features of the conduit fastener assembly;

FIG. 14 is a perspective view of another example of a conduit fastener assembly including a lock assembly in a locked position;

FIG. 15 is a cross-section view of the conduit fastener assembly of FIG. 14, the lock assembly in the locked position;

FIG. 16 is an exploded perspective view of the conduit fastener assembly of FIG. 14;

FIG. 17 is a perspective view of a tube fitting of the conduit fastener assembly of FIG. 14;

FIG. 18 is a perspective view of a portion of the conduit fastener assembly of FIG. 14, the conduit fastener assembly including a conduit nut, a bias member, a lock member, and a sleeve;

FIG. 19 is a perspective view of the conduit nut of the conduit fastener assembly of FIGS. 14 and 18;

FIG. 20 is a perspective view of the sleeve of the conduit fastener assembly of FIGS. 14 and 18;

FIG. 21 is a perspective view of the lock member of the conduit fastener assembly of FIGS. 14 and 18;

FIG. 22 is a perspective view of the bias member of the conduit fastener assembly of FIGS. 14 and 18;

FIG. 23 is an enlarged perspective view a portion of the conduit fastener assembly of FIG. 14, with a portion of the lock assembly illustrated as transparent to show features of the conduit fastener assembly;

FIG. 24 is an enlarged cross-section view a portion of the conduit fastener assembly of FIG. 14, the lock assembly in an unlocked position; and

FIG. 25 is an enlarged perspective end view of a portion of the conduit fastener assembly of FIG. 14, the lock assembly in the unlocked position.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms such as “about,” “approximately,” and “substantially” are not to be limited to the precise value specified.

In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Relative descriptors used herein such as upward, downward, left, right, up, down, length, height, width, thickness, and the like are with reference to the figures, and not meant in a limiting sense. Additionally, the illustrated embodiments can be understood as providing exemplary features of varying detail of certain embodiments, and therefore, features, components, modules, elements, and/or aspects of the illustrations can be otherwise combined, interconnected, sequenced, separated, interchanged, positioned, and/or rearranged without materially departing from the disclosed fastener assemblies. Additionally, the shapes and sizes of components are also exemplary and can be altered without materially affecting or limiting the disclosed technology.

The conduit fastening devices and systems described herein are typically used to fixedly connect or join two conduit ends or to couple a conduit end to another assembly, such as a manifold, a valve, a tank, and the like. Accordingly, the conduit fastening devices and system are useful with fittings and connectors such as fuel line connectors. The conduit fastening devices and systems are used in a variety of applications such as, without limitation, aerospace applications, automotive applications, industrial applications, building applications, fittings, and fuel line connectors. Among other features and benefits, the disclosed conduit fastening devices and systems described herein provide locking and vibration resistant conduit fastener assemblies. For example, as described in the embodiments herein, when a tool is used with the associated conduit fastener assembly, teeth or detent members on a lock assembly engage or disengage notches of a conduit nut, a gland, and/or a lock washer. When the teeth are engaged with the notches, the conduit nut is locked in rotation due to a rotational locking relationship of the lock assembly to a fitting body. When the detent members are disengaged from the notches, the conduit nut is rotationally free relative to the fitting body. The advantages and other features of the technology disclosed herein will become more readily apparent to those having ordinary skill in the art from the following detailed description of the embodiments taken in conjunction with the drawings.

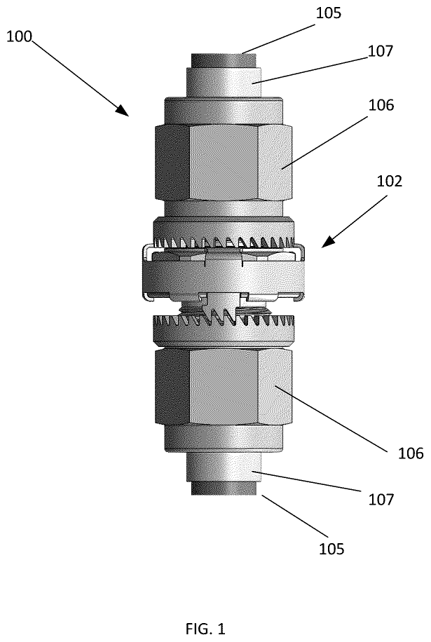

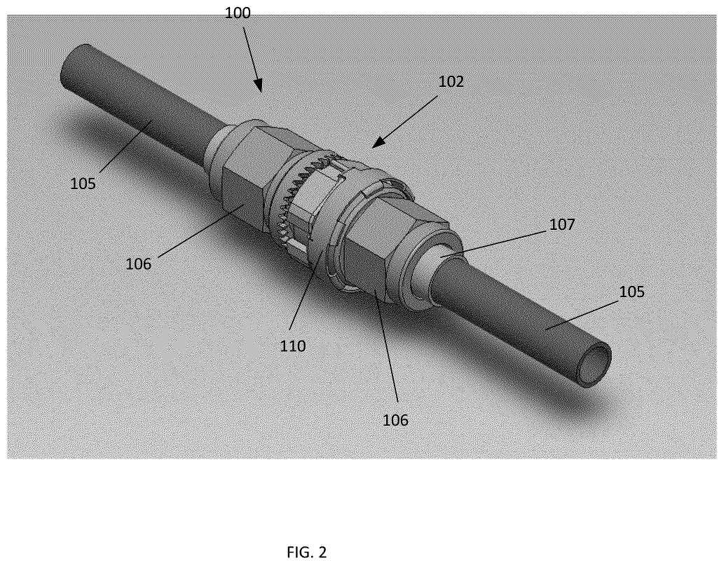

FIG. 1 is a side view of an example of a conduit fastener assembly 100 including a lock assembly 102 in a locked position. FIG. 2 is a perspective view of the conduit fastener assembly 100 with the lock assembly 102 in an unlocked position. In the example, the conduit fastener assembly 100 generally includes a tube fitting 104 defining a longitudinal axis “A”, the lock assembly 102 releasably coupled to the tube fitting 104, and a pair of conduit nuts 106. In other embodiments, the conduit fastener assembly 100 may include different components without departing from some aspects of the disclosure. For example, the conduit fastener assembly 100 may include less than or more than two of the conduit nuts 106.

Referring to FIGS. 1-6, in the example, the conduit fastener assembly 100 is arranged as a flare fitting. For example, the tube fitting 104 is configured to couple to one or more flared tubes 105. The flared tubes 105 may each include a ferrule 107 that receives and engages the respective conduit nut 106. In the example, the flared tubes 105 are connected together by the conduit fastener assembly 100 such that the flared tubes 105 are in fluid communication with each other and the conduit fastener assembly 100 facilitates fluid transfer therebetween. Accordingly, the conduit fastener assembly 100 may include seals or other standard components to facilitate fluid transfer. In other embodiments, the conduit fastener assembly 100 is arranged as a flareless fitting such as, for example, a cone and thread fitting that includes a female threaded ferrule or collar configured to threadably couple to an end portion of a cone and thread tubing. Alternatively, the conduit fastener assembly 100 is any type of conduit fastener assembly, for example, and without limitation, a compression fitting, a flare fitting, a flareless fitting, a bite-type fitting, and/or a mechanical grip-type fitting.

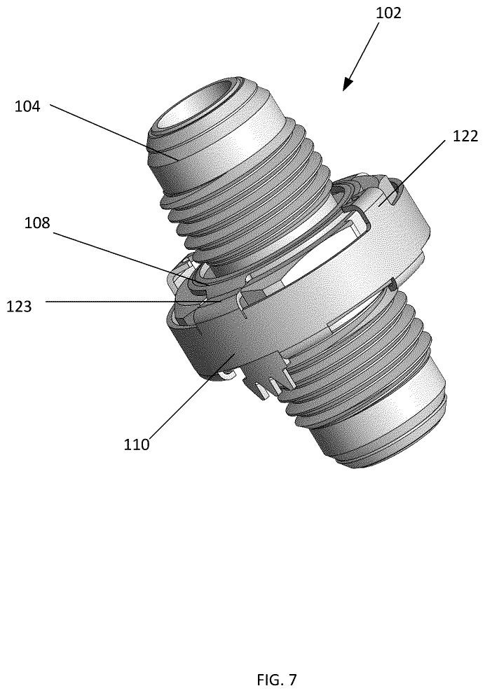

As seen in FIGS. 7-9, the lock assembly 102 includes a lock member 108 and a sleeve 110. The lock member 108 includes an annular body 112 and at least one axially-extending spring finger 114 coupled to the annular body 112. In the example, the lock member 108 includes a pair of the axially-extending spring fingers 114 on opposite sides of the annular body 112. Each axially-extending spring finger 114 includes a fixed end 116 coupled to the annular body 112 and a free end 118 opposite the fixed end 116. The free end 118 is movable in a radial direction when the lock assembly 102 is switched between the locked position and the unlocked position. The lock assembly 102 includes teeth 120 that extend axially from the free end 118. In the example, the teeth 120 are integrally formed as a single piece with the axially-extending spring finger 114 and the annular body 112.

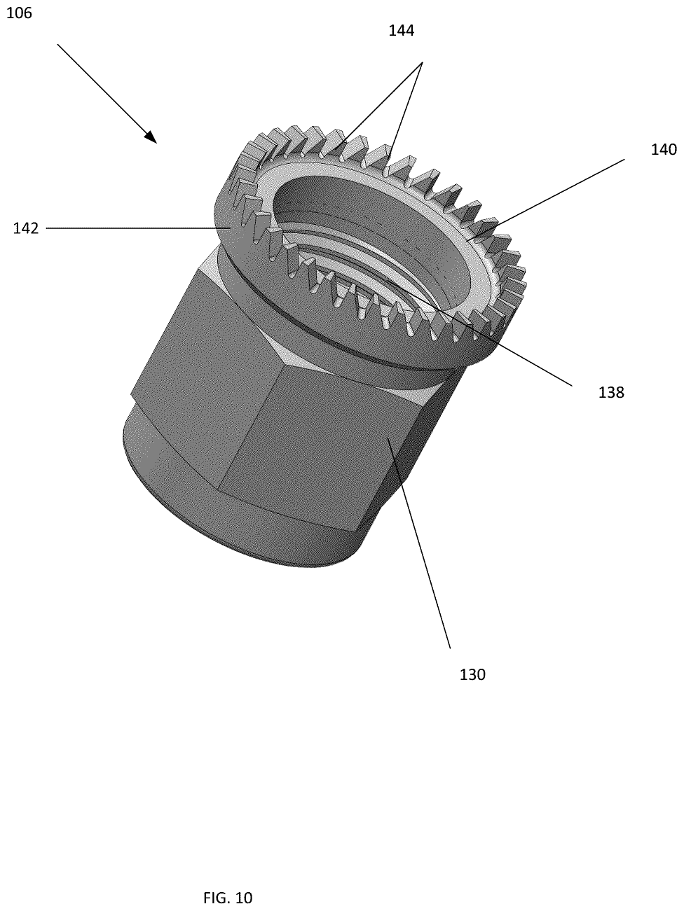

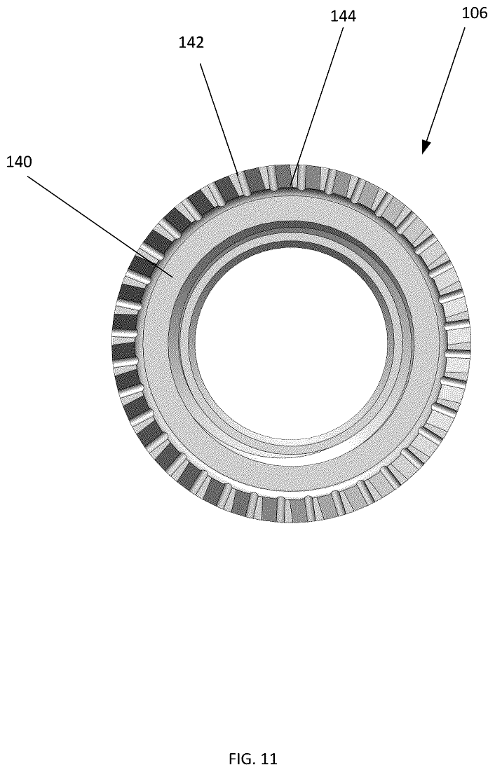

The sleeve 110 extends circumferentially around the tube fitting 104 and around the lock member 108 coupled to the tube fitting 104. The sleeve 110 includes tabs 123 that extend radially inward from the sleeve 110 and are arranged to engage the axially-extending spring fingers 114 and the tube fitting 104. In addition, the sleeve 110 includes tabs 122 that extend radially inward from the sleeve 110 and are located adjacent one of the conduit nuts 106. Teeth 124 are disposed on the tabs 122 that are located adjacent one of the conduit nuts 106. The sleeve 110 is displaced (e.g., displaced axially and/or rotated) to switch the lock assembly 102 between the locked position and the unlocked position. In the example illustrated in FIGS. 1-13, the sleeve 110 is displaced axially to switch the lock assembly 102 between the locked position and the unlocked position.

The tube fitting 104 includes a fitting body 126 and male threaded portions 128. The male threaded portions 128 extend axially along a longitudinal axis “A” from opposite sides of the fitting body 126. The male threaded portions 128 are configured to engage female threaded bodies 130 of the conduit nuts 106. In the example, the conduit fastener assembly 100 includes two of the conduit nuts 106 coupled to opposite ends of the fitting body 126. The fitting body 126 includes a peripheral surface 134 having at least one axially-extending slot 136, 137 defined therein.

In the example, the peripheral surface 134 of the tube fitting 104 has a pair of the axially-extending slots 136 circumferentially aligned relative to and arranged to receive the axially-extending spring fingers 114. The peripheral surface 134 of the tube fitting 104 has a pair of the axially-extending slots 137 circumferentially aligned relative to and arranged to receive the tabs 122 of the sleeve 110.

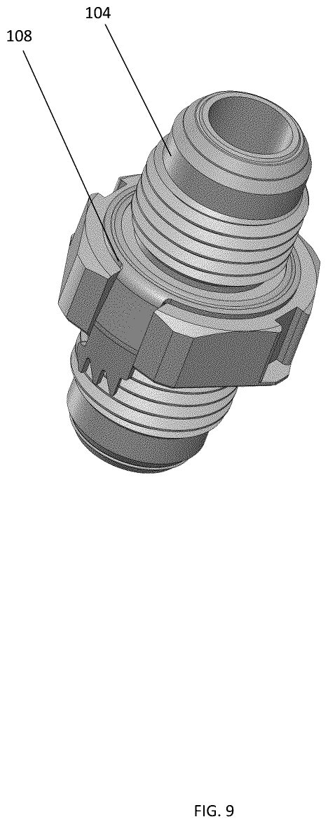

Each conduit nut 106 has a threaded body 130 that extends axially, as seen in FIG. 9. The body 130 defines an inner cavity 138 sized and shaped to receive the male threaded portions 128 of the tube fitting 104 therein. The conduit nut 106 includes threads on an interior of the body 130 that are configured to threadingly engage the male threaded portions 128 of the fitting body 126.

In addition, each conduit nut 106 includes a flange 140 extending radially outward from an end of the body 130. A circumferential axially-extending wall 142 extends about a periphery of the flange 140. The circumferential wall 142 comprises notches or teeth 144 formed on an end of the circumferential wall 142. In the example, each conduit nut 106 includes thirty-six of the notches 144 that are equally spaced around the entire circumference of the circumferential wall 142. The notches 144 extend axially and are arranged to engage the teeth 120 of the lock member 108 and the teeth 124 of the sleeve 110, as shown in FIGS. 1, 3, and 4. In other embodiments, the notches 144 may extend radially from the circumferential wall 142 and/or the flange 140.

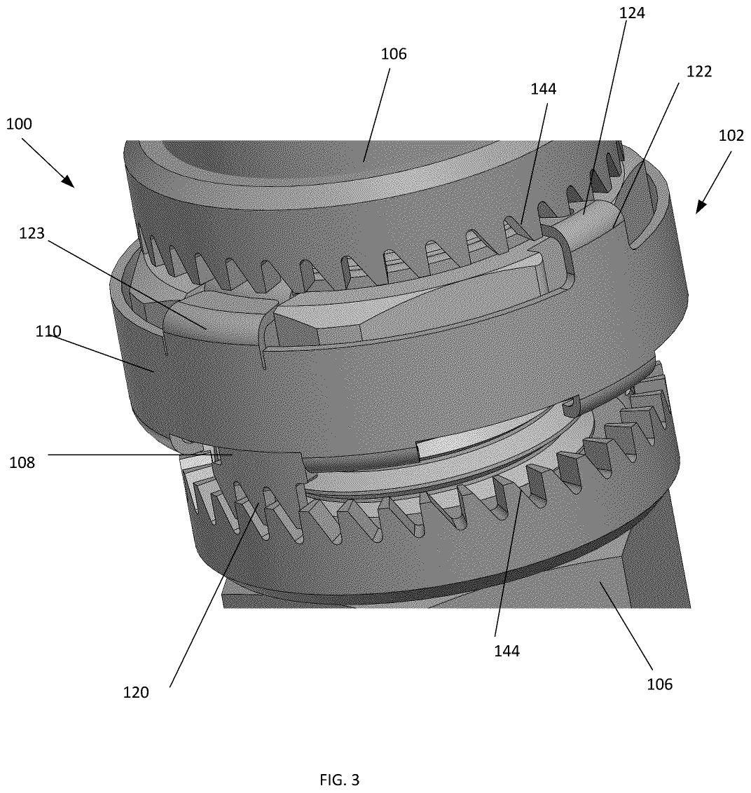

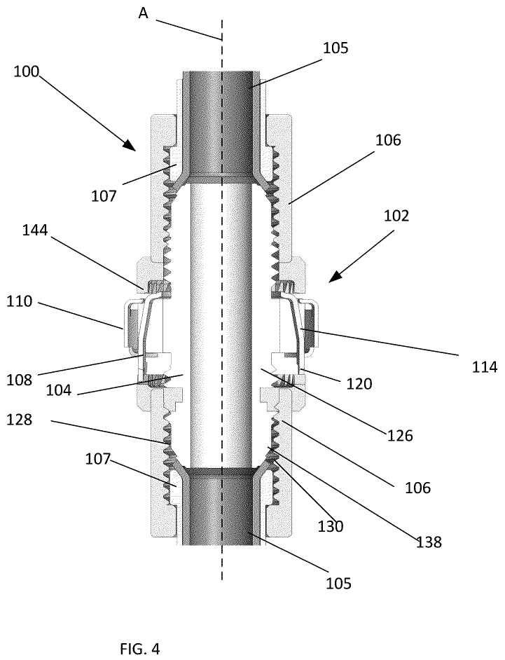

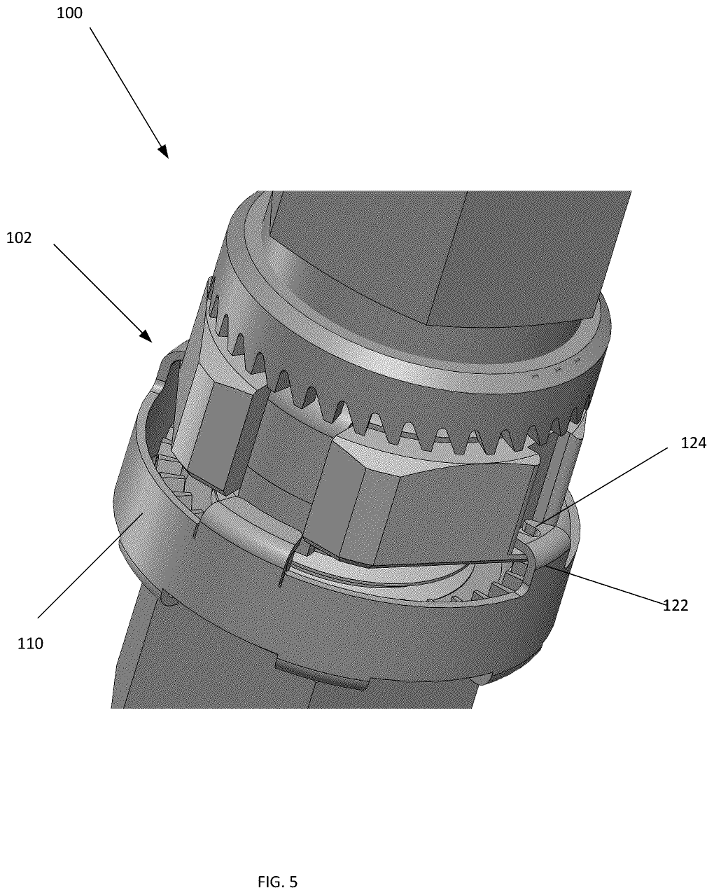

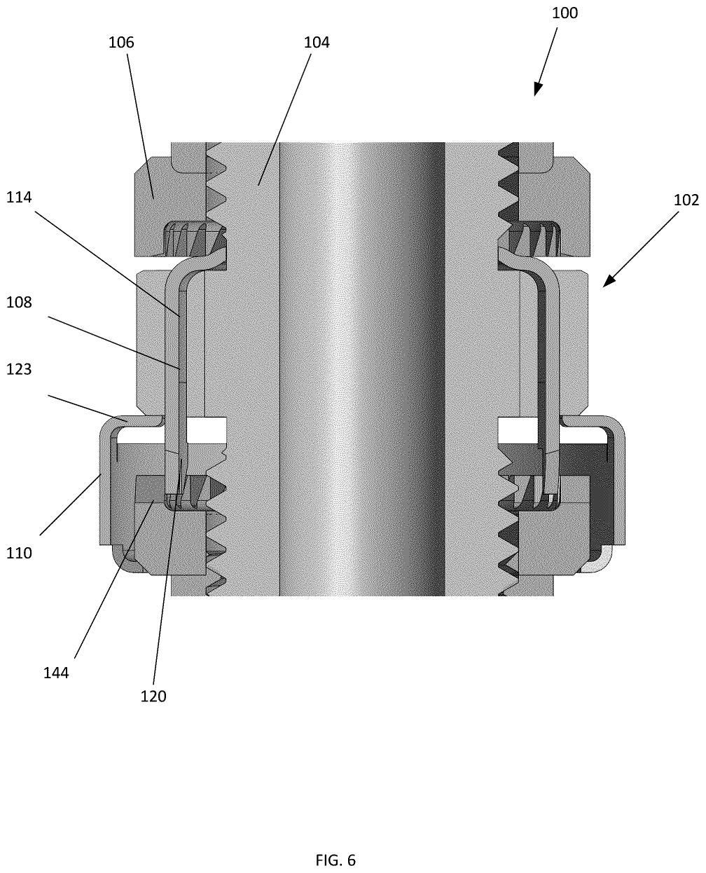

The lock assembly 102 is positionable between a locked position (shown in FIGS. 3 and 4) in which the teeth 120, 124 are engaged with the notches 144 and an unlocked position (shown in FIGS. 5 and 6) in which the teeth 120, 124 are spaced from the notches 144. The tube fitting 104 is fixed against rotation within the inner cavities 138 of the conduit nuts 106 when the lock assembly 102 is in the locked position, and the tube fitting 104 is rotatable within the inner cavities 138 when the lock assembly 102 is in the unlocked position.

The lock assembly 102 may include a bias component to bias the lock assembly 102 toward the locked position and/or the unlocked position. For example, in some embodiments, a bias component is disposed between the lock member 108 and the fitting body 126 and/or between the lock member 108 and the sleeve 110 to facilitate biasing the lock assembly 102 toward the locked position and/or the unlocked position. In the example, the spring fingers 114 are flexible and resilient such that the spring fingers 114 act as bias components to bias the lock assembly 102 toward the locked position. In particular, the spring fingers 114 act as leaf springs and are configured to bias the teeth 120 in a radially outward direction and bias the sleeve 110 in an axial direction toward the upper conduit nut 106.

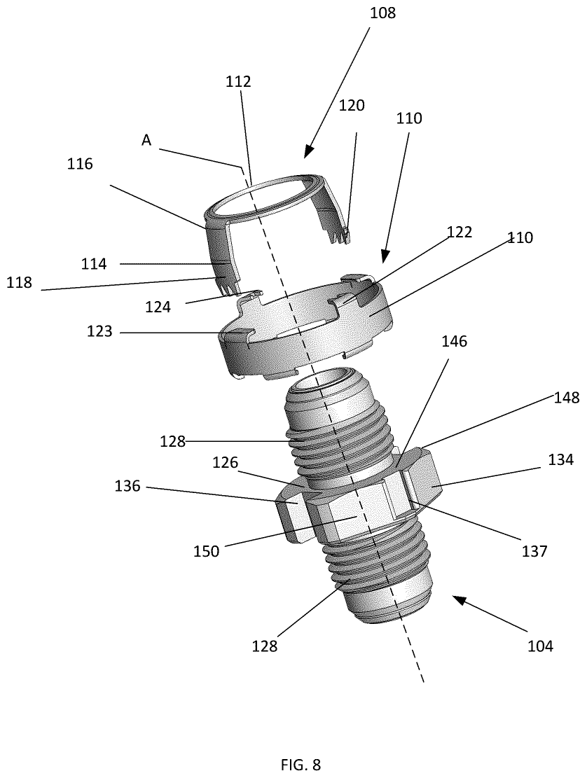

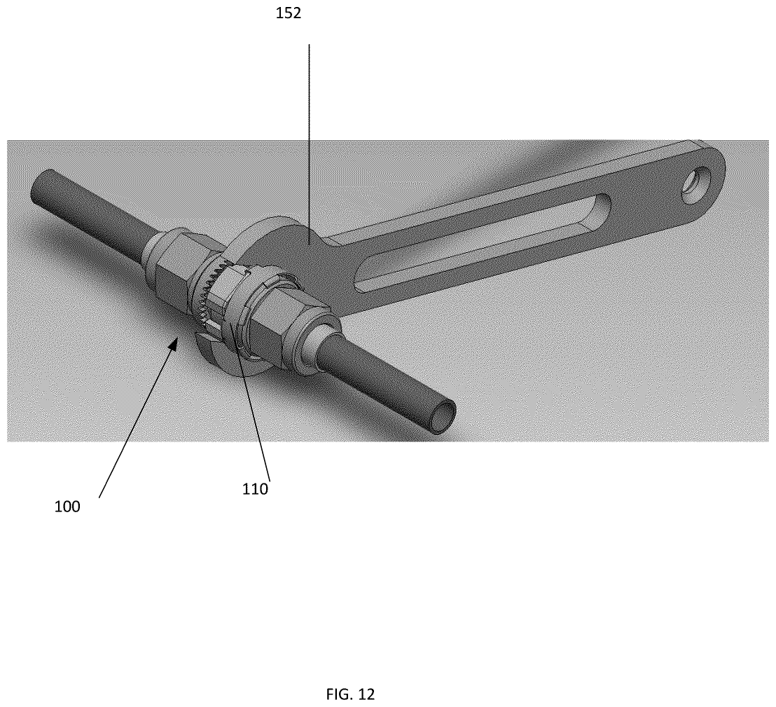

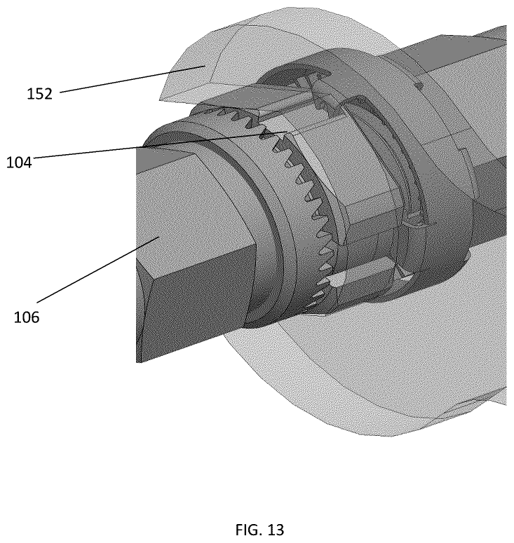

As illustrated in FIGS. 8 and 9, in the example, the fitting body 126 of the tube fitting 104 includes a shoulder 146 with one or more slotted circumferential faces 148 and one or more continuous faces 150. The slotted circumferential faces 148 and continuous faces 150, collectively, define tool engagement surfaces that extend substantially axially the fitting body 126. The tool engagement surfaces are configured in a hexagonal-shaped arrangement, although other configurations are contemplated. As seen in FIGS. 12 and 13, the tool engagement surfaces correspond to one or more tools 152, for example, and without limitation, a wrench and/or a socket. As such, the tool engagement surfaces facilitate tightening and/or loosening the conduit fastener assembly 100 using common hand tools, and without requiring use of a specialized tool.

In the example, each slotted circumferential face defines one of the axial slots 136 or the axial slots 137. In the example, two of the axial slots 136 extend generally axially along respective slotted circumferential faces between the top and bottom surfaces of the fitting body 126, and each have a circumferential width sized to receive the spring finger 114 of the lock member 108. In the example, the tube fitting 104 includes the two axial slots 136 disposed on diametrically-opposed slotted circumferential faces, i.e. on slotted circumferential faces that are substantially parallel to each other and generally symmetrical with respect to longitudinal axis “A.” In addition, another two of the axial slots 137 extend generally axially along slotted circumferential faces part of the distance between the top and bottom surfaces of the fitting body 126, and each have a circumferential width sized to receive the tabs 122 of the sleeve 110. The slots 137 that receive the tabs 122 have a ledge to engage and retain the tabs 122 within the slots 137 when the sleeve 110 moves axially. The slots 137 facilitates fixing lock member 108 and the sleeve 110 rotationally with respect to the tube fitting 104 when the axial slots 136, 137 are aligned with the spring fingers 114 and the tabs 122. In particular, the spring fingers 114 snap into the axial slots 136 to facilitate coupling lock member 108 to the tube fitting 104. In addition, the slots 137 facilitate the sleeve 110 sliding axially along the longitudinal axis A without rotating and while remaining coupled to the fitting body 126. In alternative embodiments, the tube fitting 104 includes a fewer or greater number of the axial slots 136, 137.

In the example, the tube fitting 104 and the conduit nut 106 are fabricated from a metal, for example, and without limitation, steel, aluminum, titanium, or a superalloy. Alternatively, the tube fitting 104, and/or the conduit nut 106 is fabricated from any material that enables the conduit fastener assembly 100 to function as described herein, such as, for example, and without limitation, composite materials, resins, fiber reinforced resins, plastics, and fiber reinforced plastics.

With reference to FIGS. 8 and 9, in the example, the annular body 112 of the lock member 108 is a generally circular ring having a predetermined wall thickness, that when combined with an internal diameter, facilitates fitting within a groove in the fitting body 126 of the tube fitting 104 and facilitate coupling the lock member 108 to the tube fitting 104. It is contemplated that annular body 112 may have shapes other than circular, for example, and without limitation, the annular body 112 may be round, oval, ellipsoid, or any other suitable shape. In the example, the annular body 112 and the spring fingers 114 of the lock member 108 are fabricated from a resilient metallic material, such as a spring steel. Alternatively, the lock member 108 is fabricated from any resilient material that enables lock member 108 to function as described herein, for example, and without limitation, resilient composite materials, resins, fiber reinforced resins, plastics, and fiber reinforced plastics.

In the example, each spring finger 114 extends axially from the annular body 112. In addition, the spring finger 114 is angled from the fixed end 116 to the free end 118 such that the spring finger 114 extends radially outward from the annular body 112. The fixed end 116 is coupled to annular body 112. The free end 118 includes the teeth 120. While the lock member 108 is described with two spring fingers 114, in alternative embodiments, the lock member 108 includes fewer or greater than two spring fingers 114, such that, for example, a respective spring finger 114 is circumferentially-positioned relative to a respective axial slot 136 of tube fitting 104.

As described above, one or more axially-extending teeth 120 (or detent members) are disposed on the free end 118 of each spring finger 114. In particular, in the example, sets of three adjacent axially-extending teeth 120 are disposed on the free ends 118 of the respective spring fingers 114. Each tooth 120 includes a sliding surface and a securing surface. The sliding surface and the securing surface of the tooth are sized and shaped to correspond to a sliding surface and a securing surface, respectively, of notches 144 of the conduit nut 106.

In addition, the sleeve 110 of the lock assembly 102 includes teeth 124 that are configured to engage notches 144 on another of the conduit nuts 106 that is opposite the conduit nut 106 engaged with the teeth 120. For example, the teeth 124 are disposed on an end of the tabs 122 on the sleeve 110 and are arranged to engage the notches 144 in the locked position of the lock assembly 102. In the example, the tabs 122 are bent and the teeth 124 extend from the tabs 122 radially inward toward the conduit nut 106. The teeth 124 are spaced from the notches 144 in the unlocked position.

In the example, the teeth 120, 124 are configured to facilitate preventing rotation that affects loosening of the conduit nuts 106 with respect to the fitting body 126, for example, in a counter-clockwise direction. Alternatively, the teeth 120, 124 are configured to facilitate preventing rotation of conduit nuts 106 in the clockwise direction, or both the counter-clockwise and the clockwise directions. While the lock member 108 is shown with three teeth 120 on each spring finger 114 and two teeth 124 on each tab 122, in alternative embodiments, lock member 108 includes fewer or greater than three teeth 120 and/or sleeve 110 includes fewer or greater than two teeth 124.

In operation, with reference to FIGS. 3 and 4, in the locked position, the sleeve 110, the lock member 108, and the conduit nuts 106 are fixed axially and rotationally relative to the fitting body 126. The sleeve 110 is moved axially along the longitudinal axis “A” to switch the lock assembly 102 between the locked position and the unlocked position. In the unlocked position shown in FIGS. 5 and 6, the conduit nuts 106 are rotationally free relative to the lock member 108 and the fitting body 126 on one side and to the sleeve 110 and the fitting body 126 on the other side. Rotation of the conduit nuts 106 relative to the fitting body 126 displaces the conduit nuts 106 axially relative to the fitting body 126 and the lock member 108.

As shown in FIGS. 3 and 4, in the locked position, the spring fingers 114 of the lock member 108 and the tabs 122 of the sleeve 110 sit within the axial slots 136, 137 of the fitting body 126. The teeth 120, 124 of the lock assembly 102 are positioned to engage the notches 144 on the conduit nuts 106. As such, the lock member 108 and the fitting body 126 are caused to rotate together. Consequently, when one or more radially-extending teeth 120 of lock member 108 and the one or more teeth 124 of the sleeve 110 seats against the notches 144 of the conduit nuts 106, the lock member 108 becomes rotationally-fixed relative to the conduit nut 106, causing the conduit nut 106 to become rotationally-fixed relative to the lock member 108 and the fitting body 126.

As described above, the spring fingers 114 of the lock member 108 are biased to facilitate maintaining locking engagement of radially-extending teeth 120 and notches 144. In the unlocked position, the sleeve 110 is displaced axially and the teeth 124 on the sleeve 110 are disengaged from the notches 144 on the conduit nut 106. In addition, axial displacement of the sleeve 110 causes each spring finger 114 to be displaced radially inward to disengage the teeth 120 from the notches 144. Accordingly, in the unlocked position, the conduit nuts 106 are able to rotate relative to the lock assembly 102 and the tube fitting 104.

With reference to FIGS. 12 and 13, to facilitate displacing the spring fingers 114 radially inward, as described herein, the tool 152, such as a conventional socket or wrench, is coupled to conduit nut 106. The tool 152 contacts the tube fitting 104 and displaces the sleeve 110 axially. As result, the teeth 124 on the sleeve 110 disengage from the notches 144 on one of the conduit nuts 106, and the teeth 120 on the lock member 108 are displaced radially and disengage from the notches 144 on the other of the conduit nuts 106. The tool 152 may hold the tube fitting 104 in place while the conduit nuts 106 are rotated either clockwise or counterclockwise about longitudinal axis “A” to displace the conduit nuts 106 axially in either direction along longitudinal axis “A,” tightening the conduit nuts 106 or loosening the conduit nuts 106 as appropriate. In some embodiments, the tool 152 may be used to rotate the tube fitting 104 relative to the conduit nuts 106.

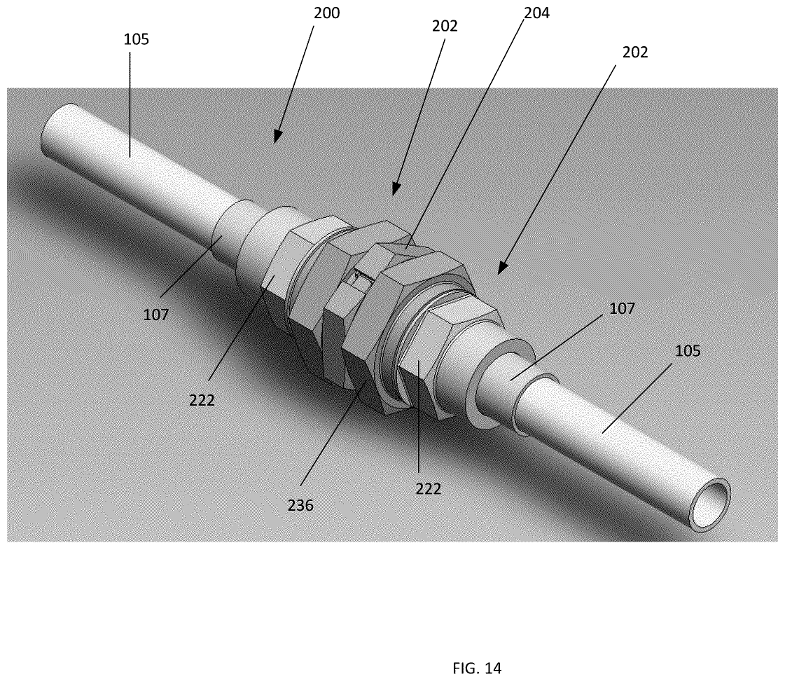

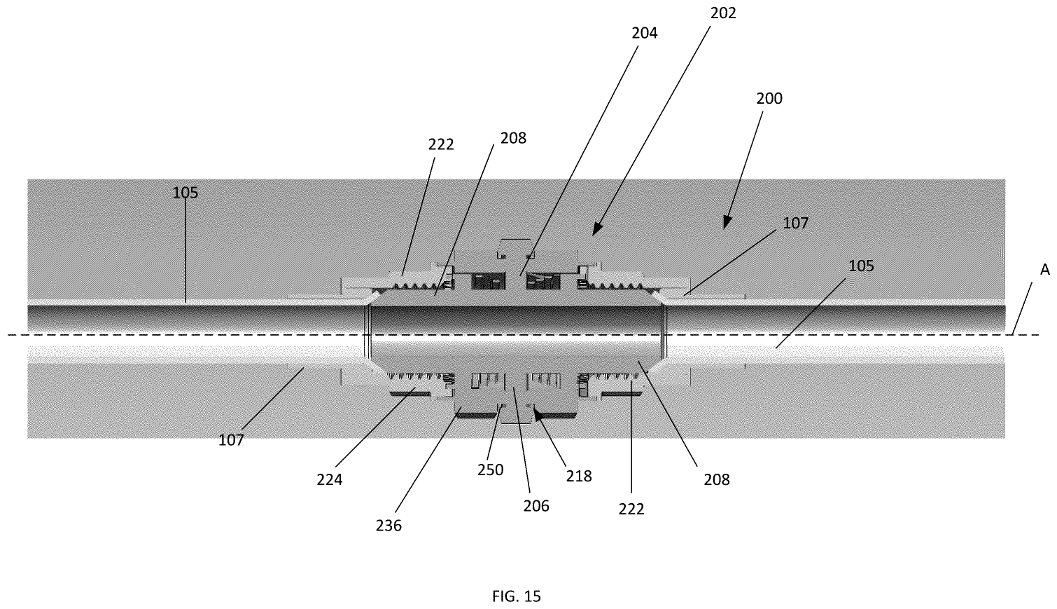

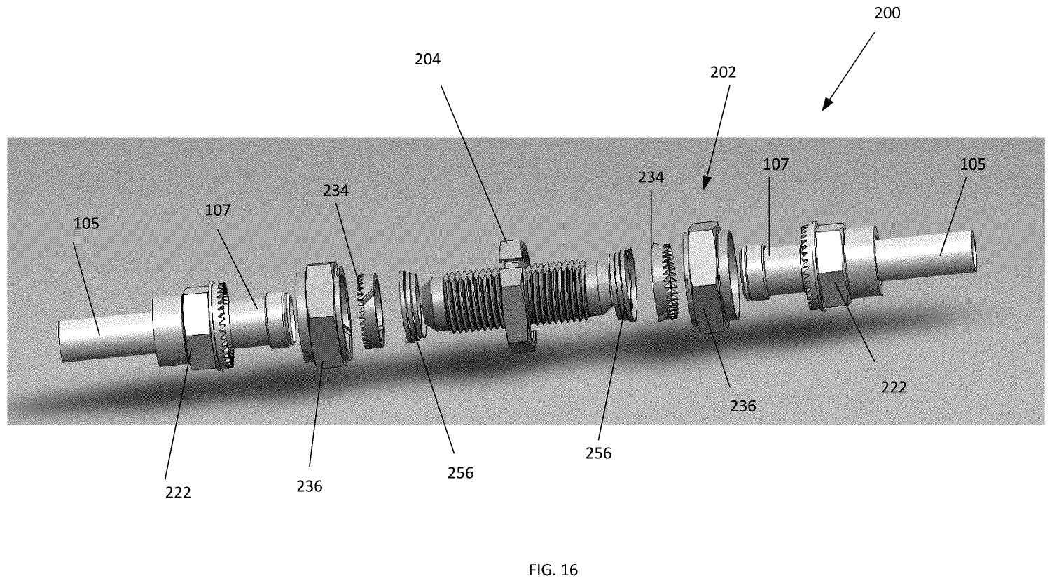

FIG. 14 is a perspective view of an example of a conduit fastener assembly 200 including a lock assembly 202 in a locked position. FIG. 15 is a cross-section view of the conduit fastener assembly 200, with the lock assembly 202 in the locked position. FIG. 16 is an exploded perspective view of the conduit fastener assembly 200. The conduit fastener assembly 200 is configured for use with a tube fitting (e.g., the tube fitting 104 shown in FIG. 1 or the tube fitting 204 shown in FIGS. 14-17) and is similar to the conduit fastener assembly 100 shown in FIG. 1 except as described herein.

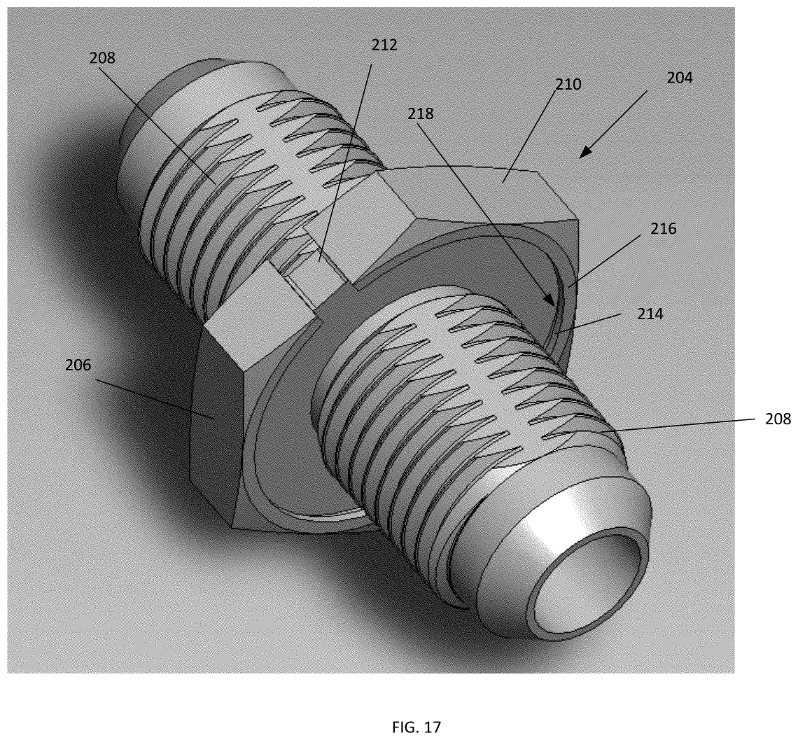

Referring to FIGS. 17-19, the tube fitting 204 shown in FIG. 17 includes a fitting body 206 and male threaded portions 208. The male threaded portions 208 extend axially along the longitudinal axis A and from opposite sides of the fitting body 206. The fitting body 206 includes a peripheral surface 210 having at least one axially-extending slot 212 defined therein. In the example, the peripheral surface 210 of the tube fitting 204 has a pair of the axially-extending slots 212. In addition, the fitting body 206 includes flanges 214 extending axially from opposite ends of the fitting body 206 and rims 216 extending radially inward from the flanges 214. The flanges 214 and the rims 216 define annular recesses 218 on ends of the fitting body 206.

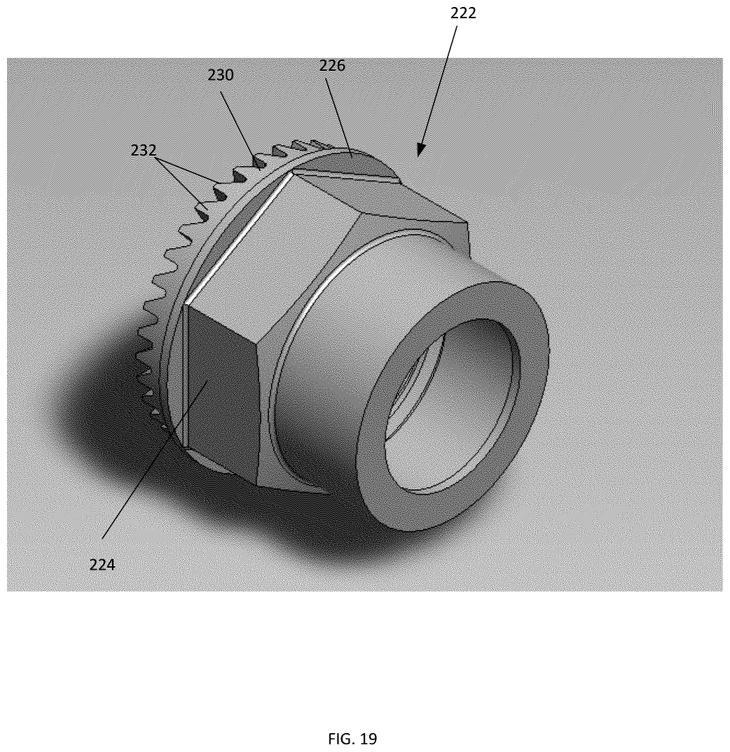

The male threaded portions 208 of the tube fitting 204 are configured to engage female threaded bodies 224 of conduit nuts 222. In the example, the conduit fastener assembly 200 includes two of the conduit nuts 222 coupled to opposite ends of the fitting body 206. Each conduit nut 222 has a threaded body 224 that extends axially, as seen in FIG. 19. The body 224 defines an inner cavity sized and shaped to receive the male threaded portions 208 of the tube fitting 204. Each conduit nut 222 includes threads on an interior of the body 224 that are configured to threadingly engage the male threaded portions 208 of the fitting body 206. For example, the conduit nuts 222 are rotated about the longitudinal axis A to tighten or loosen the conduit nuts 222 on the male threaded portions 208.

In addition, each conduit nut 222 includes a flange 226 extending radially outward from an end of the body 224. A circumferential axially-extending wall 230 extends about a periphery of the flange 226. The circumferential wall 230 comprises notches or teeth 232 formed on an end of the circumferential wall 230. The notches 232 extend axially. In other embodiments, the notches 232 may extend radially from the circumferential wall 230 and/or the flange 226.

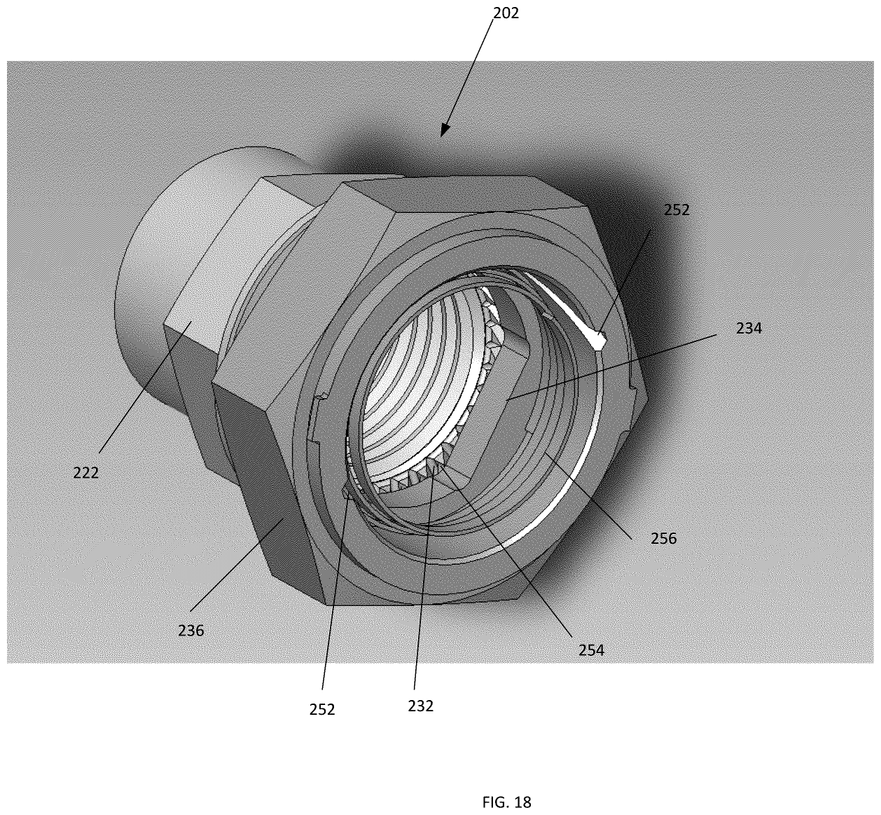

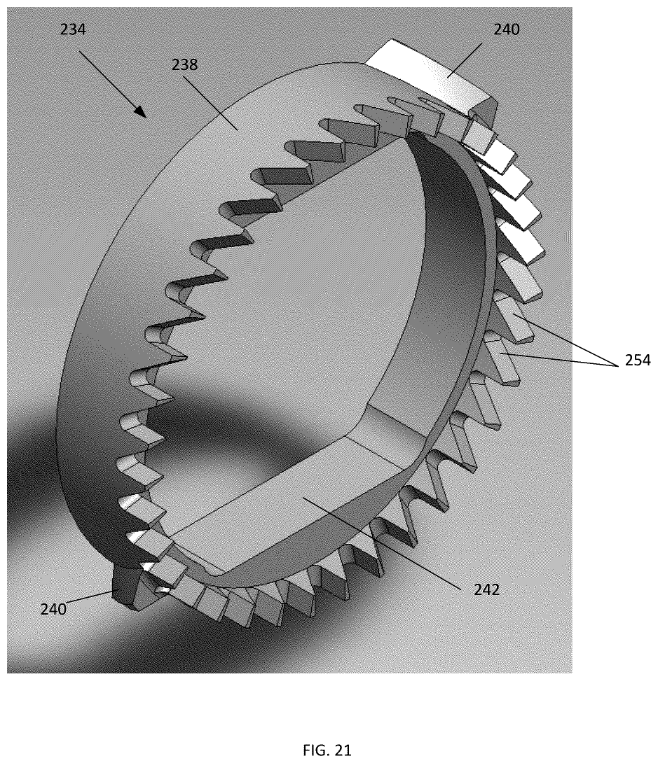

As seen in FIGS. 18, 20, and 21, the lock assembly 202 includes a lock member 234 and a sleeve 236. The lock member 234 includes an annular body 238 and at least one protuberance 240 that extends radially outward from an outer surface of the annular body 238. In the example, teeth 254 and the at least one protuberance 240 are integrally formed as a single piece with the annular body 238. In addition, the lock member 234 includes at least one anti-rotation feature that is configured to engage the tube fitting 204 (shown in FIG. 17) and fix rotation of the lock assembly 202 relative to the tube fitting. For example, in the illustrated example, the lock member 234 includes at least one planar surface 242 that engages the tube fitting 204.

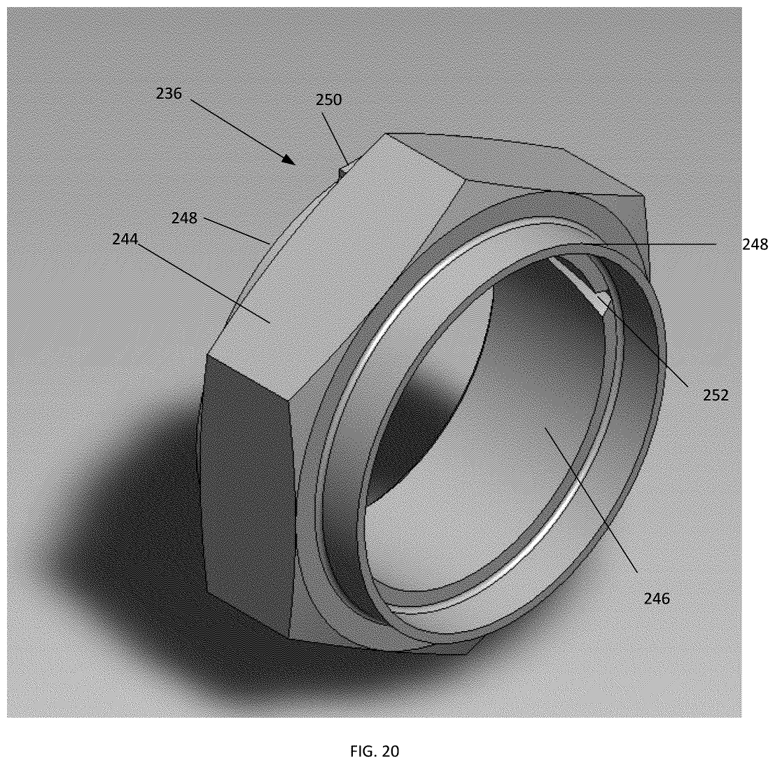

Referring to FIG. 20, the sleeve 236 includes a body 244 defining a bore 246, flanges 248 extending axially from opposite ends of the body 244, and at least one tab 250 extending radially outward from at least one of the flanges 248. In the example, the sleeve 236 includes a pair of diametrically opposite tabs 250 on an end of the sleeve 236 adjacent the fitting body 206 (shown in FIGS. 15 and 16). The tabs 250 are sized and shaped to fit through the slots 212 on the end of the tube fitting 204 and be received in the annular recess 218 to secure the sleeve 236 to the tube fitting 204, as shown in FIG. 15. When the sleeve 236 is secured to the tube fitting 204, the tabs 250 prevent axial movement of the sleeve 236 relative to the tube fitting but allow rotation of the sleeve 236 relative to the tube fitting 204.

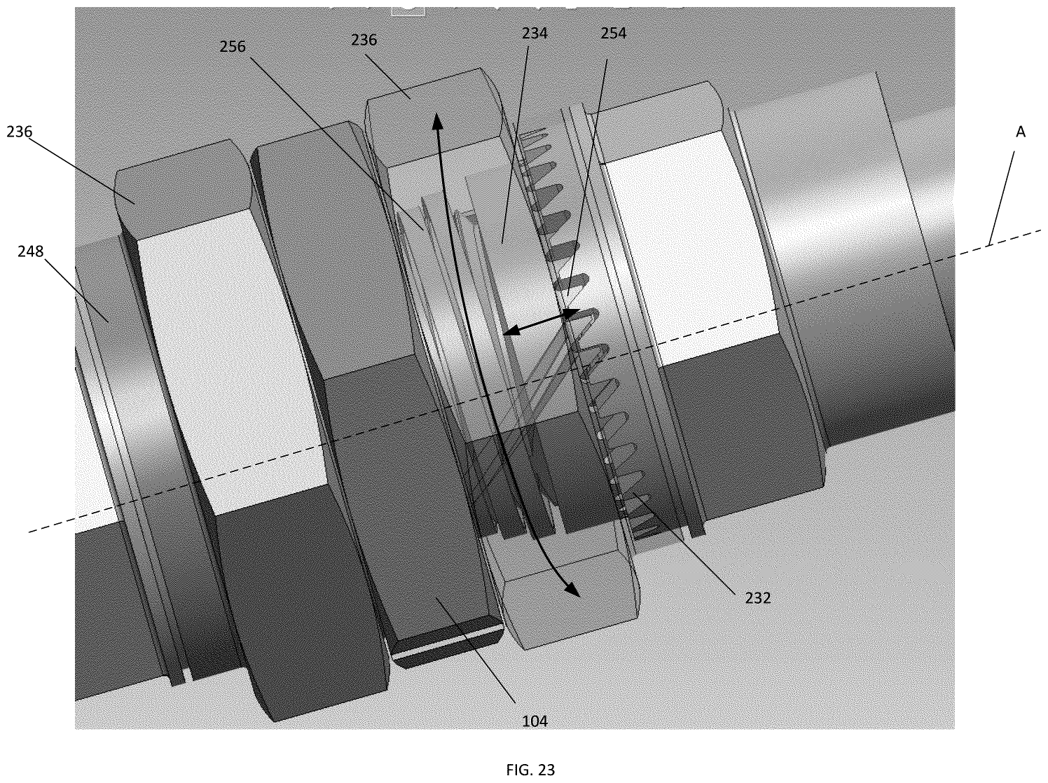

As seen in FIGS. 23-25, the sleeve 236 extends circumferentially around the tube fitting 204 and around the lock member 234 when the lock assembly 202 is coupled to the tube fitting 204. The sleeve 236 includes angled grooves or engagement features 252 that are defined on an inner circumferential surface of the body 244 and are arranged to receive the protuberances 240 of the lock member 234. The sleeve 236 is displaced (e.g., displaced axially and/or rotated) to switch the lock assembly 202 between the locked position and the unlocked position.

At least one of the lock member 234 or the sleeve 236 includes teeth 254 that are arranged to engage the notches 232 of the conduit nut 222. For example, the lock member 234 includes teeth 254 that extend axially from an end of the annular body 238 and are arranged to engage the notches 232 of the conduit nut 222, as shown in FIGS. 18 and 23. In the example, the fastener assembly 200 includes two of the lock members 234 that are positioned on opposite sides of the tube fitting 204 with teeth 254 that are arranged to engage the conduit nuts 222.

In the example, the teeth 254 are configured to facilitate preventing rotation that affects loosening of the conduit nuts 222 with respect to the fitting body 206, for example, in a counter-clockwise direction. Alternatively, the teeth 254 are configured to facilitate preventing rotation of conduit nuts 222 in the clockwise direction, or both the counter-clockwise and the clockwise directions.

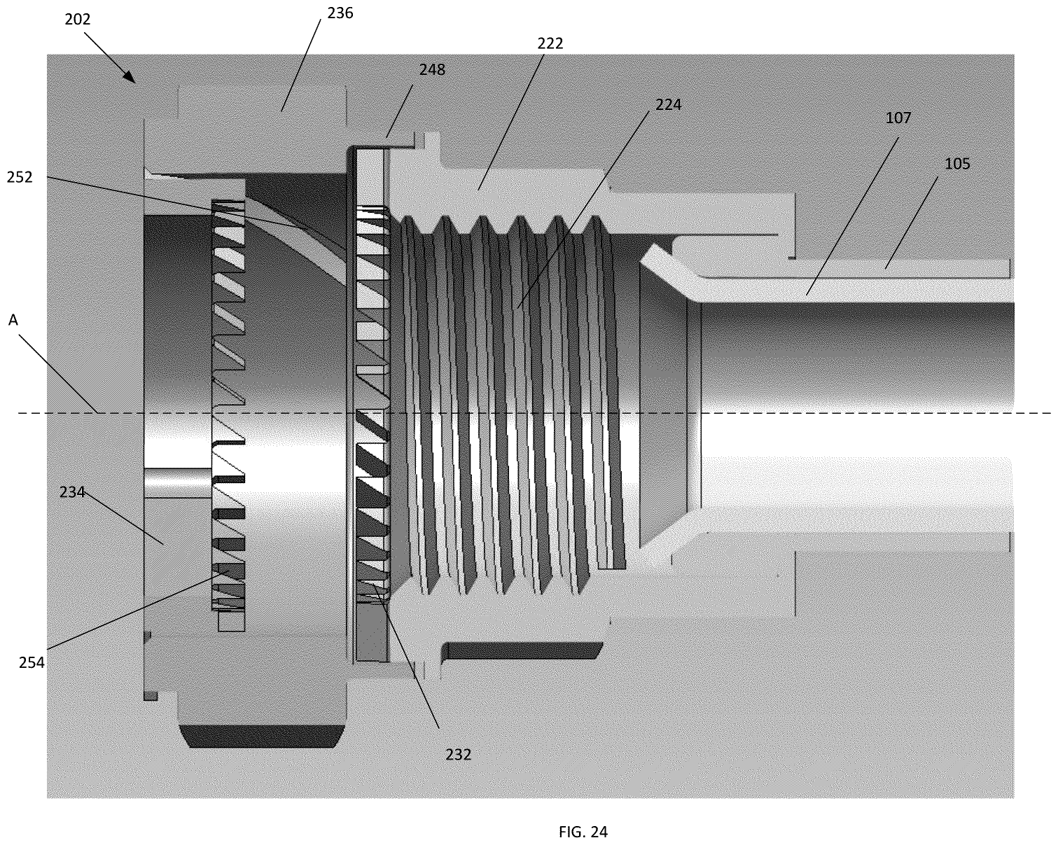

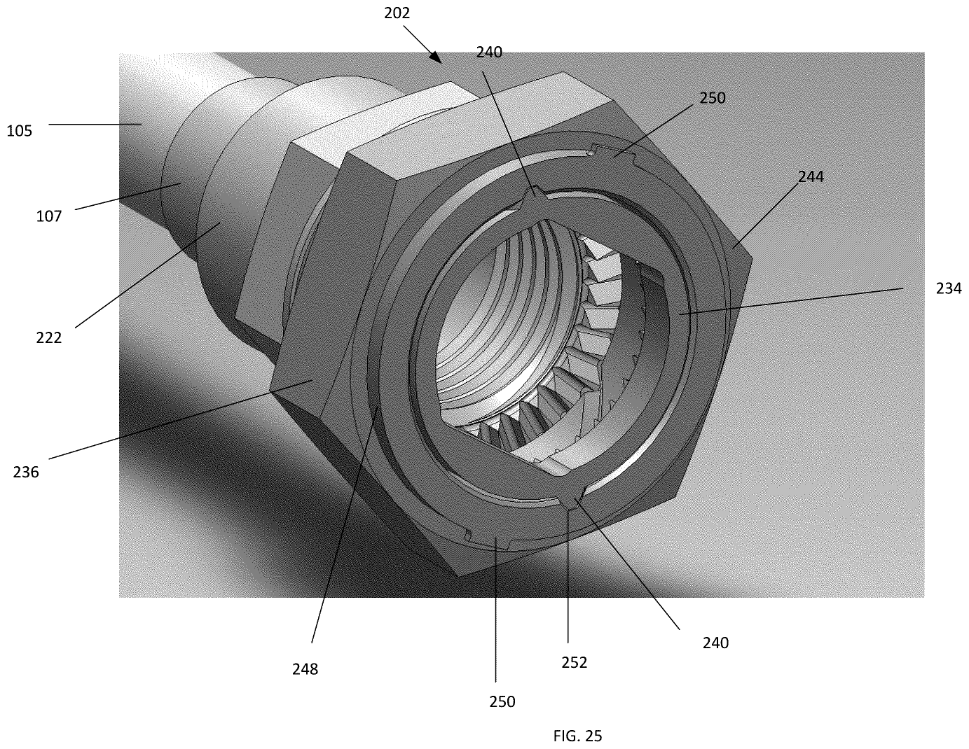

The lock assembly 202 is positionable between a locked position (shown in FIGS. 18 and 23) in which the teeth 254 are engaged with the notches 232 and an unlocked position (shown in FIGS. 24 and 25) in which the teeth 254 are spaced from the notches 232. The tube fitting 204 is fixed against rotation within the inner cavities of the conduit nuts 222 when the lock assembly 202 is in the locked position, and the tube fitting 204 is rotatable within the inner cavities when the lock assembly 202 is in the unlocked position. In addition, the flange 226 of the conduit nut 222 may contact the flange 248 of the sleeve 236 opposite the fitting body 206 when the lock assembly 202 is in the locked position. Accordingly, the lock member 234 may be completely enclosed by the conduit nut 222 and the sleeve 236.

In the example, the sleeve 236 is positionable to cause the lock assembly 202 to move between the locked position and the unlocked position. For example, as illustrated in FIGS. 23-25, the sleeve 236 is rotated about the longitudinal axis A to switch the lock assembly 202 between the locked position and the unlocked position. Rotation of the sleeve 236 causes the lock member 234 to move within the sleeve 236 in a direction parallel to the longitudinal axis A. For example, the angled grooves 252 extend circumferentially and longitudinally to form a helix about the longitudinal axis A. The angled grooves 252 are arranged to cause the protuberances 240 within the angled grooves 252 to move along the longitudinal axis A when the sleeve 236 is rotated. As a result, the sleeve 236 causes axial movement of the lock member 234 when the sleeve 236 is rotated.

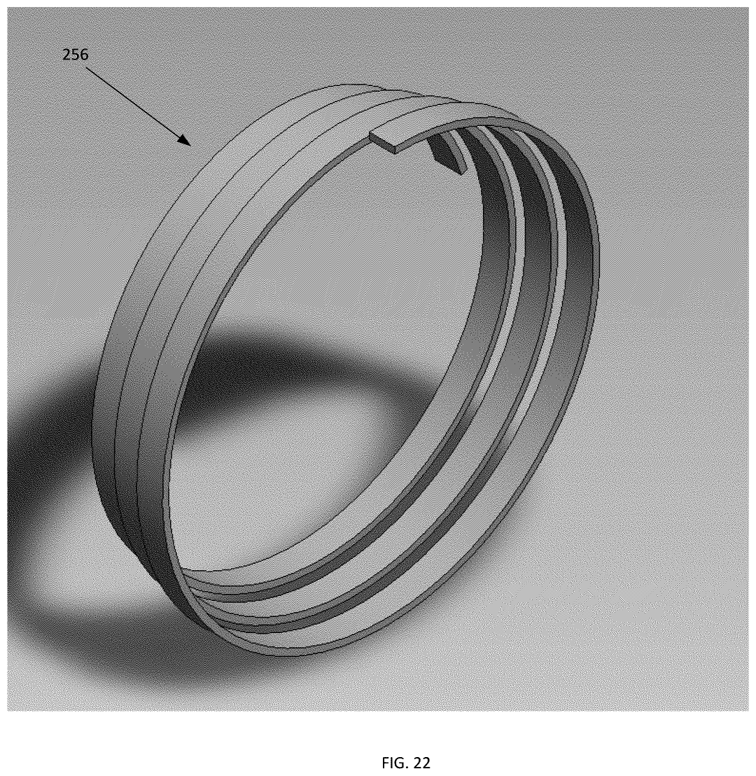

Referring to FIGS. 18 and 22, the lock assembly 202 includes a bias component 256 to bias the lock assembly 202 toward the locked position and/or the unlocked position. For example, in some embodiments, the bias component 256 is disposed between the lock member 234 and the fitting body 206 and/or between the lock member 234 and the sleeve 236 to facilitate biasing the lock assembly 202 toward the locked position and/or the unlocked position. In the example, the bias component 256 comprises a volute spring that is positioned between the lock member 234 and the fitting body 206 to bias the lock member 234 toward the conduit nut 222 and thereby the lock assembly 202 toward the locked position. For example, the bias component 256 is fabricated from a resilient metallic material, such as spring steels. In some embodiments, the bias component 256 includes bias mechanisms such as a helical spring or stacked Belleville washers.

In operation, with reference to FIGS. 23-25, in the locked position, the lock member 234 and the conduit nuts 222 are fixed axially and rotationally relative to the fitting body 206. The sleeve 236 is rotated about the longitudinal axis “A” to switch the lock assembly 202 between the locked position and the unlocked position. In the unlocked position shown in FIGS. 24 and 25, the conduit nuts 222 are rotationally free relative to the lock member 234 and the fitting body 206. Rotation of the conduit nuts 222 relative to the fitting body 206 displaces the conduit nuts 222 axially relative to the fitting body 206 and the lock member 234.

As shown in FIGS. 23, in the locked position, the teeth 254 of the lock assembly 202 are positioned to engage the notches 232 on the conduit nuts 222 and cause the lock member 234 and the conduit nut 222 to rotate together. In addition, the engagement surfaces of the lock member 234 engage the fitting body 206 and prevent rotation of the lock assembly 202 relative to the fitting body 206. As a result, the lock assembly 202 is fixed against rotation and the conduit fastener assembly 200 is prevented against loosening when the conduit nut 222 is tightened onto the tube fitting 204 and the lock assembly 202 is in the locked position. For example, when one or more radially-extending teeth 254 of lock member 234 seats against the notches 232 of the conduit nut 222, the lock member 234 becomes rotationally-fixed relative to the conduit nut 222, causing conduit nut 106 to become rotationally-fixed relative to the lock member 234 and the fitting body 206.

As described above, the bias components 256 bias the lock members 234 towards the conduit nuts 222 to facilitate maintaining locking engagement of the radially-extending teeth 254 and notches 232. In the unlocked position of each lock assembly 202, the sleeve 236 is rotated and the lock member 234 is displaced axially such that the teeth 254 on the lock member 234 are disengaged from the notches 232 on the conduit nut 222. Accordingly, in the unlocked position, the conduit nuts 222 are able to rotate relative to the lock assembly 202 and the tube fitting 204.

Embodiments of the disclosure provide numerous benefits and technical advantages. For example, the fastener assemblies provide for simple and secure couplings of components. For example, the fastener assemblies may be used for hydraulic connectors and/or fuel line fittings. The fastener assemblies provide a positive mechanical lock and eliminate the requirement for safety wire on couplings. In addition, the fastener assemblies provide relatively high vibration and temperature resistance and are able to be used to provide secure and reliable connections in applications in which the fastener assemblies may experience excessive vibrations and high temperatures. Moreover, the locking mechanisms for the fastener assemblies provide a reversible and reusable solution that is simple to install and utilizes standard tooling to reduce the costs of using or installing the fastener assemblies.

Examples of systems and methods for rotationally locked conduit fastener assemblies are described above. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fastener assembly comprising:
a tube fitting defining a longitudinal axis;
a lock assembly releasably coupled to the tube fitting and including teeth; and
a conduit nut defining an inner cavity sized and shaped to receive a portion of the tube fitting therein, the conduit nut comprising a circumferential wall extending about a periphery of the conduit nut and notches, wherein the lock assembly is positionable between a locked position in which the teeth are engaged with the notches and an unlocked position in which the teeth are spaced from the notches, the tube fitting is fixed against rotation within the inner cavity when the lock assembly is in the locked position, and the tube fitting is rotatable within the inner cavity when the lock assembly is in the unlocked position.

2. A fastener assembly in accordance with claim 1, wherein the lock assembly comprises a lock member and a sleeve, wherein at least one of the lock member or the sleeve comprises the teeth, and wherein the sleeve is displaced axially or rotated to switch the lock assembly between the locked position and the unlocked position.

3. A fastener assembly in accordance with claim 2, wherein the lock member comprises an annular body and an axially-extending spring finger coupled to the annular body, the axially-extending spring finger comprising a free end that that is movable in a radial direction when the lock assembly is switched between the locked position and the unlocked position, wherein the teeth extend axially from the free end.

4. A fastener assembly in accordance with claim 3, wherein the tube fitting comprises a peripheral surface having an axially-extending slot defined therein, wherein the tube fitting is arranged to receive the axially-extending spring finger at least partly within the axially-extending slot.

5. A fastener assembly in accordance with claim 2, wherein the teeth extend axially from the lock member, and wherein the lock member is displaced axially when the lock assembly is switched between the locked position and the unlocked position.

6. A fastener assembly in accordance with claim 2, wherein at least one of the lock member or the sleeve is configured to engage the tube fitting and to fix rotation of the lock assembly relative to the tube fitting when the lock assembly is in the locked position.

7. A fastener assembly in accordance with claim 2, wherein the sleeve includes a tab, wherein the teeth extend from an end of the tab, and wherein the teeth are spaced axially from the notches when the lock assembly is in the unlocked position.

8. A fastener assembly in accordance with claim 1, wherein, in the unlocked position, the teeth are displaced radially inward of the circumferential wall and the teeth are disengaged from the notches such that the conduit nut is rotatable relative to the tube fitting.

9. A fastener assembly in accordance with claim 1 further comprising a bias component positioned to bias the lock assembly toward the locked position.

10. A lock assembly for a tube fitting defining a longitudinal axis, the lock assembly comprising:
a lock member;
a sleeve, wherein at least one of the lock member or the sleeve comprises teeth; and
a conduit nut defining an inner cavity sized and shaped to receive a portion of the tube fitting therein, the conduit nut including notches, wherein the lock assembly is positionable between a locked position in which the teeth are engaged with the notches and an unlocked position in which the teeth are spaced from the notches, the tube fitting is fixed against rotation within the inner cavity when the lock assembly is in the locked position, and the tube fitting is rotatable within the inner cavity when the lock assembly is in the unlocked position.

11. A lock assembly in accordance with claim 10, wherein the sleeve is displaced axially or rotated to switch the lock assembly between the locked position and the unlocked position.

12. A lock assembly in accordance with claim 10, wherein at least one of the lock member or the sleeve is configured to engage the tube fitting and to fix rotation of the lock assembly relative to the tube fitting when the lock assembly is in the locked position.

13. A lock assembly in accordance with claim 10, wherein the sleeve includes a tab, wherein the teeth extend from an end of the tab, and wherein the teeth are spaced axially from the notches when the lock assembly is in the unlocked position.

14. A lock assembly in accordance with claim 10, wherein the teeth extend from an end of the sleeve, and wherein the teeth are spaced axially from the notches when the lock assembly is in the unlocked position.

15. A lock assembly in accordance with claim 10 further comprising a bias component positioned to bias the lock assembly toward the locked position.

16. A conduit fastener assembly comprising:
a tube fitting defining a longitudinal axis, the tube fitting including a fitting body having a first portion and a second portion;
a first conduit nut defining a first inner cavity sized and shaped to receive the first portion of the tube fitting therein and comprising a first wall extending about a periphery of the first conduit nut, the first wall comprising first notches;
a second conduit nut defining a second inner cavity sized and shaped to receive the second portion of the tube fitting therein and comprising a second wall extending about a periphery of the second conduit nut, the second wall comprising second notches; and
a lock assembly releasably coupled to the tube fitting and including teeth, wherein the lock assembly is positionable between a locked position in which the teeth are engaged with the first and second notches and an unlocked position in which the teeth are spaced from the first and second notches, the tube fitting is fixed against rotation within the first inner cavity and the second inner cavity when the lock assembly is in the locked position, and the tube fitting is rotatable within the first inner cavity and the second inner cavity when the lock assembly is in the unlocked position.

17. A conduit fastener assembly in accordance with claim 16, wherein the lock assembly comprises a lock member and a sleeve, wherein at least one of the lock member or the sleeve comprises the teeth, and wherein the sleeve is displaced axially or rotated to switch the lock assembly between the locked position and the unlocked position.

18. A conduit fastener assembly in accordance with claim 17, wherein the teeth include first teeth arranged to engage the first notches and second teeth arranged to engage the second notches, the lock member comprises the first teeth, and the sleeve comprises the second teeth.

19. A conduit fastener assembly in accordance with claim 17, wherein at least one of the lock member or the sleeve is configured to engage the tube fitting and to fix rotation of the lock assembly relative to the tube fitting when the lock assembly is in the locked position.

20. A conduit fastener assembly in accordance with claim 16 further comprising a bias component positioned to bias the lock assembly toward the locked position.
